(19) United States
(12) Patent Application Publication
(10) Pub. No.: US 2001/0044013 A1
(43) Pub. Date: Nov. 22, 2001

(54) Thin film transferrable electric components

(76) Inventors: Neil McDonough, Paxton, MA (US); Daniel P. Segall, Longmeadow, MA (US); Michael E. Paul, Brookfield, MA (US); Thomas J. Comerford, Spencer, MA (US); John R. Pennace, Paxton, MA (US)

Correspondence Address: Samuels, Gauthier & Stevens LLP, 225 Franklin Street, Suite 3300, Boston, MA, 02110, US

(21) Appl. No.: 09/817,548

(22) Filed: Mar. 26, 2001

Related U.S. Application Data
(63) Continuation of application No. 09/219,559, filed on Dec. 23, 1998, now abandoned.
Application No. 09/219,559 is a continuation-in-part of application No. 08/610,158, filed on Feb. 29, 1996, now Pat. No. 5,902,437.
Application No. 08/610,158 is a division of application No. 08/381,086, filed on Jan. 31, 1995, now Pat. No. 5,751,256.
Application No. 08/381,086 is a continuation-in-part of application No. 08/206,865, filed on Mar. 4, 1994, now abandoned.

(51) Int. Cl. B32B 3/18

(52) U.S. Cl. 428/202; 428/209; 156/241; 156/234; 156/233

(57) ABSTRACT

The invention provides a thin film transferrable composite comprising a carrier film, a first electrically conductive material, and adhesive. The first electrically conductive material is formed as a deposit on the carrier film and is integrally associated with first portions of the composite, and separably associated with second portions of the composite. The adhesive is arranged to coact with the first electrically conductive material for applying the composite to a receiving surface. The carrier film is separable from the second portions of the electrically conductive material with the first portions of the electrically conductive material remaining with the carrier film. The second portions of the electrically conductive material define a transferrable electrical component.

### BACKGROUND OF THE INVENTION

The present application is a continuation-in-part application of copending U.S. Ser. No. 08/610,158 filed Feb. 29, 1996, which is a divisional application of U.S. Ser. No. 08/381,086 filed Jan. 31, 1995, which is a continuation-in-part application of U.S. Ser. No. 08/206,865 filed Mar. 4, 1994.

The invention generally relates to transferable films, and in particular relates to transferable films including electrical components. The invention is suitable for use in, but not limited to, the manufacture of resonant tag labels that are used in electronic article surveillance and identification systems.

Conventional electronic article surveillance systems are utilized widely as an effective deterrent to unauthorized removal of items from specified surveillance areas. In surveillance systems of this type, articles to be monitored are provided with resonant tag labels that are used to detect the presence of the articles as they pass through a surveillance zone. The surveillance zone typically comprises an electromagnetic field of a predetermined frequency generated in a controlled area. The tag label resonates at the frequency of the electromagnetic field or another predetermined frequency. The resonant frequency is detected by the system and provides an alarm indicating the presence of the label and, therefore, the article. For deactivation, a strong surge current is induced in the resonant tag label in order to produce a short-circuit.

Presently available resonant tag labels include conductive layers separated by a dielectric layer. Specifically, such labels include circuits having a dielectric carrier film with an inductive spiral applied to one side thereof, such as an appropriately configured metal foil, that is terminated at each end by first and second conductive areas. Matching conductive areas are applied to the opposite side of the dielectric carrier film to form a capacitor, thus completing an inductive-capacitive tuned resonant circuit upon establishing a direct electrical connection between the conductive areas on both sides of the dielectric film.

Label thickness is increased significantly by the reliance on relatively thick films as the dielectric medium for physically separating and supporting the conductive components of the circuit. Thickness is further increased by the application of additional films or coatings to protect and stabilize the label. The resulting overall thickness of the labels makes it difficult if not impossible to effectively conceal them from detection and unauthorized removal by those determined to foil the surveillance system.

With respect to identification systems, conventional methods typically involve automatic reading of bar codes (UPC) provided on indicia receptive labels. Unfortunately, a disadvantage in bar code systems includes the need for the article to which the label is applied and the bar code itself to be oriented such that the reading or detection beam can properly read the bar coded information. This problem can be serious if the objects being identified are to be sorted and the objects are random as to delineation and orientation.

It is therefore an object of the present invention to provide a resonant tag label that is constructed with thin coatings so that the tag label may be disguised, for example, underlying a conventional printed label.

It is a further object of the present invention to provide a resonant tag label and method for making same that utilizes a minimum of components and which is separable from an initial film used primarily during the configuration of the tag label.

It is yet another object of the present invention to provide a resonant tag label that is responsive to a plurality of frequencies.

It is an additional object of the present invention to provide a resonant tag label that provides proper electronic identification information regardless of the orientation of the label.

It is yet another object of the present invention to provide a thin, frangible resonant tag label that in essence requires a substrate film or a substrate object to which it is applied in order to remain a viable construction.

It is a further object of the present invention to provide inexpensive adhesively applicable electrical circuits and portions thereof using extremely thin electrical conductor material.

### SUMMARY OF THE INVENTION

Accordingly, the present invention provides a frangible substrate that includes a plurality of integrally joined layers deposited successively on a removable carrier film. One or more of the layers are electrically conductive and configured to function within an electrical circuit. The substrate is transferrable from the carrier film onto a receiving surface and is otherwise inseparable from the carrier film without attendant disruption of the electrically conductive portions. In an alternative embodiment, the substrate comprises a label and includes an adhesive layer for applying the label to a receiving surface, such that the plurality of integrally joined layers including the electrical components are transferrable to the receiving surface and are otherwise inseparable from the carrier film without destruction of the electrical components.

Through proper choice of conductive materials, dielectric coatings and adhesive, resonant tag labels made in accordance with the present invention can be designed such that a source tag package could be easily recyclable. This is not the case with conventional labels that employ films such as polyethylene and conductive layers such as aluminum foil. The mixture of film and foils together with the other packaging material makes any attempt to recycle the package much more difficult. In addition, the easily transferable electric components of the present invention are able to be positioned either in combination with an existing label or circuit structure or other parts of an existing package in such a manner as to not obstruct vital information on the package or severely alter the aesthetics of the package. Given the costs and the environmental restraints on packaging, alteration of the aesthetics is not a trivial issue. Furthermore, the present invention has the advantage of easy concealability due to the thin membrane construction, and furthermore, allows for incorporation in deformable packages or containers.

In accordance with an alternative embodiment of the present invention, there is provided a resonant tag label and method of making same including a first electrically conductive pattern applied to a first dielectric layer, a dielectric coating which is adhered to at least the first electrically conductive pattern, a second electrically conductive antenna pattern adhered to the dielectric coating, and a second dielectric layer which is applied to at least the second electrically conductive pattern. According to one embodiment of the invention, the first dielectric layer is a separable carrier film and the second dielectric layer is an adhesive layer. The adhesive is applicable to a substrate and has a peel strength greater than that required to separate the carrier film from the rest of the label structure.

According to another embodiment of the invention, a third electrically conductive pattern is adhered to the second dielectric layer such that the second and third electrically conductive patterns form a second frequency tuned antenna circuit. In a further aspect, additional electrically conductive patterns and dielectric coatings, respectively, are alternately adhered to the second dielectric layer in a stacked construction so as to form a plurality of additional frequency tuned antenna circuits.

In another embodiment, similarly structured antenna circuits are constructed on portions of the first dielectric layer proximate to the first frequency tuned antenna circuit in a planar construction so as to form additional frequency tuned antenna circuits.

In another embodiment of the invention, thin frangible films including a conductive component may be transferred to a receiving electric circuit, and the electric component may be either inductively coupled or directly connected to the receiving circuit.

### BRIEF DESCRIPTION OF THE DRAWINGS

The following description of the invention may be further understood with reference to the accompanying drawings in which the thickness and other dimensions of components are not shown to scale and have been exaggerated for purposes of illustration. In particular:

FIG. 1 shows a perspective exploded view of a resonant tag label in accordance with the present invention;

FIG. 2 shows a cross-sectional view of a portion of a resonant tag label in which the electric conductors on opposite sides of the dielectric layer are inductively coupled to one another;

FIG. 3 shows a cross-sectional view of the resonant tag label of FIG. 1 in which the electric conductors are in direct electrical contact with one another;

FIG. 4 shows a perspective view of an alternative embodiment of a resonant tag label in accordance with the present invention;

FIG. 5 shows a perspective view of an alternative embodiment of a resonant tag label in accordance with the present invention in which antenna circuits are provided in a stacked construction;

FIG. 6 shows a plane view of an alternative embodiment of the resonant tag label in accordance with the present invention in which antenna circuits are provided in an adjacently disposed planar construction;

FIGS. 7-11 show cross-sectional views of alternative embodiments of resonant tag labels in accordance with the present invention;

FIG. 12A shows a perspective view of a thin film transferrable circuit in accordance with the present invention;

FIG. 12B shows a cross-sectional view of the thin film transferable circuit of FIG. 12A taken along the line 12B-12B thereof;

FIG. 12C shows a cross-sectional view of the thin film transferable electric component of FIGS. 12A and 12B being applied to a receiving substrate including a receiving electric circuit;

FIG. 12D shows a cross-sectional view of the thin film transferable electrical component of FIGS. 12A-12C electrically connected to the receiving electrical substrate;

FIG. 13A shows a cross-section view of another embodiment of a thin film transferable electrical component of the invention;

FIG. 13B shows a cross-sectional view of the thin film transferable electrical component of FIG. 13A being applied to a receiving substrate including a receiving electrical circuit;

FIG. 14A shows a cross-section view of another embodiment of a thin film transferable electrical component of the invention;

FIG. 14B shows a cross-sectional view of the thin film transferable electrical component of FIG. 13A being applied to a receiving substrate including a receiving electrical circuit;

FIG. 15A shows a cross-section view of another embodiment of a thin film transferable electrical component of the invention;

FIG. 15B shows a cross-sectional view of the thin film transferable electrical component of FIG. 13A being applied to a receiving substrate including a receiving electrical circuit;

FIG. 15C shows a cross-sectional view of another embodiment of a thin film transferable electrical component of the invention;

FIG. 16 shows a cross-sectional view of another embodiment of a thin film transferable electrical component of the invention being applied to a carrier substrate between two rollers;

FIG. 17 shows an exploded view of a thin film transferable electrical component of the invention, a receiving circuit to which the electrical component will be inductively coupled, and an intermediate dielectric; and

FIG. 18 shows a membrane switch employing transferrable electrical components of the invention.

### DETAILED DESCRIPTION OF THE ILLUSTRATED EMBODIMENTS

With reference now to the drawings, one embodiment of a resonant tag label 10 in accordance with the present invention is disclosed in FIG. 1. Initially, there is provided a carrier film 12 that serves as a stable base for the label structure. For exemplary purposes, the carrier film may be any one of the following: polypropylene with a preferred thickness of 2.0 mils, polyester with a preferred thickness of 0.50 to 1.5 mils, polyethylene with a preferred thickness of 2.5 mils, PVC with a preferred thickness between 2.0 to 5.0 mils, or conventional paper with a preferred thickness of 1.4 to 6 mils. As will be described in more detail hereinafter, the carrier film either remains as part of the label structure and is configured to receive indicia, or as in the preferred embodiment, the carrier film is removed during adhesive application of the label to a substrate.

The carrier film 12 includes a surface on which the label structure is constructed. Preferably, the carrier film surface is configured as a low surface energy film, such as polypropylene, where the intrinsic surface tension of the film makes it a releasable or low adhesion surface. Alternatively, the film 12 is provided with a release coating or breakcoat 14. The difference between a breakcoat and a release coating or an inherently release material, will be described below in further detail. Generally, however, a release coating (or material) is designed to remain with the carrier film upon separation of the carrier film from a receiving substrate to which the carrier film has been adhered, while a breakcoat is designed to separate from the carrier film and be transferred to the receiving substrate.

The specific applications of the resonant tag label, as well as the type of underlying carrier film, typically determines which type of breakcoat can be utilized. An example of such an application would be in a situation where the thermal transfer requirement is such that the breakcoat or transfer resin should not melt while the temperatures are high enough to soften heat reactivated adhesives being employed to adhere the label to a substrate. Such a situation would limit the type of resins utilized. In addition, if a polyester carrier film is used, it is possible that a release coat on the polyester side against the transfer coat may be required. Similar examples that will determine the breakcoat include the need for enhanced moisture vapor barrier properties, and other environmental/product resistance requirements. Furthermore, it will be appreciated that the film 12 need not have a releasable surface, break coating, etc., thus accommodating permanent application of the subsequent layers added to the film. In still further embodiments, the material removed with the carrier film may have utility in addition to, or in place of, the material that is transferred to the receiving substrate.

The release coatings that are preferred to be used are silicones, either pure or silicone modified acrylics. An alternative would be to supply a true breakcoat, i.e. a coating designed to have a preferential adhesion strength to the layers developed thereon which are transferred.

The aforementioned carrier film 12 and optional breakcoating are preferably both flexible. Thus, the components will be useful in fabrication of the resonant tag label 10, enabling a series of labels to be fabricated with a continuous web process, as is well known in the art.

A first electrically conductive pattern 16, e.g. a plate, is applied to the carrier film surface or its breakcoat 14. The pattern 16 is produced by a selective metallization process, preferably by registered deposition of a conductive material at specific locations within the format of the label. For example, application of conductive inks or electrodeless metallic deposition. Conductive ink coatings result in the range of 0.05 to 0.5 mil, while electrodeless depositions range from 0.001 to 0.1 mil. It will be appreciated by those of skill in the art that any of the conductive patterns described herein can be metallic or conductive non-metals, such as carbon or silicon based conductors.

Another exemplary process for applying the conductive pattern is by vacuum deposition of metals such as aluminum or silver, which is carried out in conjunction with a continuous mask band having register holes that allow the vaporized metal to pass through and condense on the web of carrier film. An alternative method of creating the conductive pattern includes the metallization of the entire carrier film surface area, and a subsequent subjection of the carrier film to a selective demetallization process to achieve the desired pattern. It will be appreciated that vacuum metallized deposits are on the order of approximately 75 Å to 300,000 Å, and preferably 10,000 Å to 50,000 Å in thickness.

The thickness of the conductive layer may determined by measuring the resistance of the deposited conductive layer and knowing the relationship that resistance is equal to the intrinsic resistance of the material multiplied by the length and divided by the cross sectional area. Intrinsic resistance values, for example, for certain metals are as follows: silver is 0.63, copper is 0.60, gold is 0.45, and aluminum is 0.38. Similarly, the thickness of non-conductive materials that are too thin to measure with a micrometer, may be determined if the material is employed as a dielectric. This is based on knowing the measured capacitance of the non-conductive material and knowing that capacitance equals the dielectric constant multiplied by the area of overlap of the parallel capacitor plates, divided by the distance between the plates. The actual thickness, therefore, of deposited materials may be non-uniform and may further be imprecise depending on the electrical performance of the material.

A further method of producing a conductive pattern involves applying a continuous conductive layer, and thereafter chemically etching, laser cutting or arc cutting the desired pattern. The continuous conductive layer is derived from vacuum metallization deposits, sputter depositions (25 Å to 12,000 Å, and preferably between about 500 Å to 3,000 Å), plasma depositions (50 Å to 10,000 Å), or conventional metallic transferring techniques.

A dielectric coating 18 is next applied to at least the first conductive pattern 16. The dielectric coating 18 can overlap the conductive pattern onto the carrier film 12 depending on the desired overall size of the resonant tag label 10. A preferred method of providing the dielectric coating is a selective printing of the dielectric material onto specified areas. The dielectric material can consist of any number of conventionally available polymeric materials, such as acrylics, polyester, polyurethanes, silicones, etc. The preferred range of thickness for this coating is 0.025 to 1.2 mils.

A second conductive pattern, which includes a conductor plate 20 and a spiral antenna pattern 21, is applied to the dielectric coating. The conductive patterns 16 and 20 together with the spiral antenna pattern 21 form an inductive tuned capacitance circuit which resonates at a desired frequency. The conductor 20 and spiral pattern 21 are produced on the dielectric coating 18 in accordance with similar processes as described with respect to the first conductor 16. The first and second conductors are inductively coupled through the dielectric coating 18.

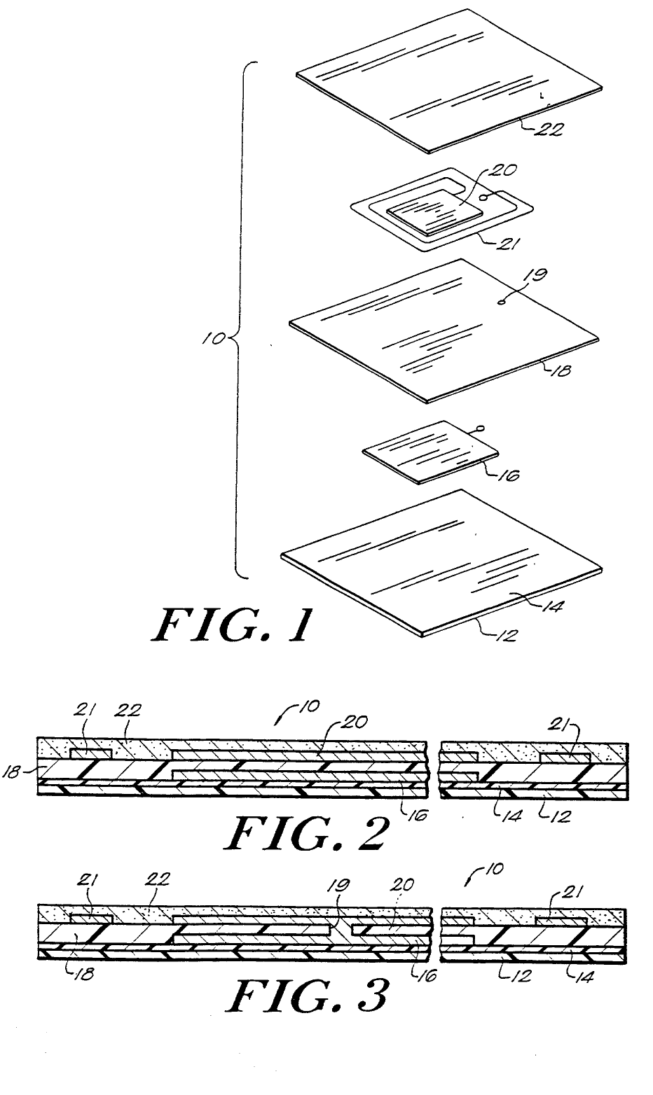

According to an alternative embodiment of the present invention as depicted in FIGS. 1 and 3, the dielectric 18 is configured with a gap or through-hole 19, which accommodates direct electrical contact between the conductors 16 and 20.

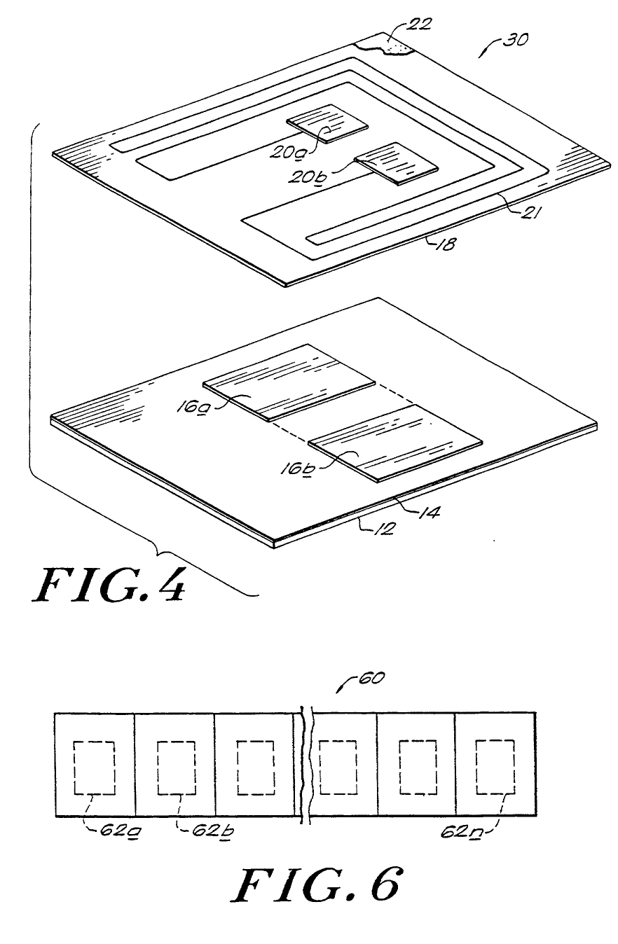

With reference now to FIG. 4, an alternative embodiment of the resonant tag label 30 is shown as including a carrier film 12 and breakcoat 14 having two conductive plates 16a, 16b, or a continuous single conductor, applied thereto. The dielectric coating 18 is then applied to at least the conductive plates 16a, 16b, and on the opposite side thereof, a conductive pattern which includes conductive plates 20a, 20b and spiral antenna pattern 21 is applied to create an inductive capacitance circuit. This configuration is an alternative method to create the proper capacitance to deliver the desired resonant frequency.

Referring back now to FIGS. 1-3, an adhesive layer 22 is applied to at least the second conductive antenna pattern. The adhesive layer is a conventional pressure sensitive or heat activated adhesive layer having a preferred thickness of 0.1 to 1.0 mil. The adhesive is utilized to bond the resonant tag label 10 to the particular substrate (not shown) to which the label is to be attached. A dielectric coating can also be applied alone or in conjunction with the adhesive layer 22, which in effect also serves as a dielectric.

It will be appreciated by those of skill in the art that an alternative form of the above described resonant tag label may be constructed by initially beginning with a dielectric coating rather than the carrier film 12, which in effect also serves as a dielectric. Instead, the carrier film is applied to the top of adhesive layer 22 to accommodate a construction wherein a transfer to the underside of an adhesive label could be made allowing for the adhesive layer 22 to be situated proximate to the adhesive on the label stock. In addition, the antenna circuit could also be constructed on the label stock itself.

The resonant tag label 10 described heretofore may subjected to plasma depositions of glass such that the conductive patterns and dielectric coating are enveloped by a glass layer in order to improve the dielectric strength and/or the overall environmental resistance of the label. In these situations, the glass coatings can be applied on top of the breakcoat so as to be under the first conductive pattern and on top of the second conductive pattern prior to the application of the adhesive layer 22. The glass coatings can be in the range of 60 to 5000 Å.

In operation, the resonant tag label 10 is applied to a selected substrate with the adhesive system 22. Thereafter, the carrier film 12 and breakcoat 14 are removed from the thus applied label structure. The adhesive system 22 preferably has a peel strength greater than that required to separate the carrier film from the label structure. Accordingly, the resonant tag label 10 as used on a substrate does not include a film as a part of the label structure. Instead, it is a combination of thin conductive and dielectric coatings as described heretofore. The only role the carrier film has in the label structure is to provide the initial support for the label components prior to application of the label to a selected substrate.

The total thickness of the resonant tag label in use is a fraction of that found in conventional resonant tag labels. The present invention is preferably of a thickness between 0.05 mil to 2.5 mils, and preferably between about 0.05 mil (5.0×10⁻⁴ inches) to 1.2 mils (1.2×10⁻³ inches), excluding adhesive, which allows the label to be readily applied to various types of substrates. Thus, the label can also be more easily hidden behind other graphic type labels. Furthermore, the thin, frangible nature of the resonant tag label of the present invention provides tamper evidence in the event that it is removed from a substrate to which it has been adhered. One of the advantages of using the above described thin layer construction is that each layer can be precisely registered to each other and to specific positions on the film, thus allowing for the spacing needed for subsequent, or prior, layers in the label structure.

An additional alternative embodiment of the present invention includes the use of the carrier film 12 as a permanent part of the resonant tag label 10 construction. In order to accomplish this, the surface 14 or the optional breakcoat is replaced by an adhesion coat or other surface treatment or preparation. In this construction, the outside surface of the carrier film 12 may be utilized as a label face to receive indicia, and to further serve to disguise the underlying circuitry.

Another alternative embodiment of a resonant tag label according to the present invention is illustrated in FIG. 5, showing a first antenna pattern 46 applied to the surface 44 of a carrier film 42. It will be appreciated that the carrier film may include a dielectric coating by itself or in conjunction with the carrier film. Subsequent layers including a first dielectric coating 48 with through-hole 49 and a conductive plate 50 are applied to the first antenna pattern 46 to form a first tuned antenna circuit 52 with a first predetermined frequency. Thereafter, consecutive layers of a second dielectric coating 54 with through-hole 55 and a second antenna pattern 56 are applied onto the conductive plate 50 to form a second tuned antenna circuit 58 with a second predetermined frequency. A final adhesive coating 59 is applied to the thus constructed label.

Accordingly, the resonant tag label of FIG. 5 is operational with respect to two different frequencies. As a further aspect of this embodiment, additional alternate layers of conductive plates and antenna patterns with a dielectric coating therebetween may be applied to the label structure, thus rendering the resonant tag label operational with respect to a plurality of frequencies. It. will be appreciated that the tuned frequencies may be altered by varying the size and/or thickness of any one of the conductive patterns or dielectric layers.

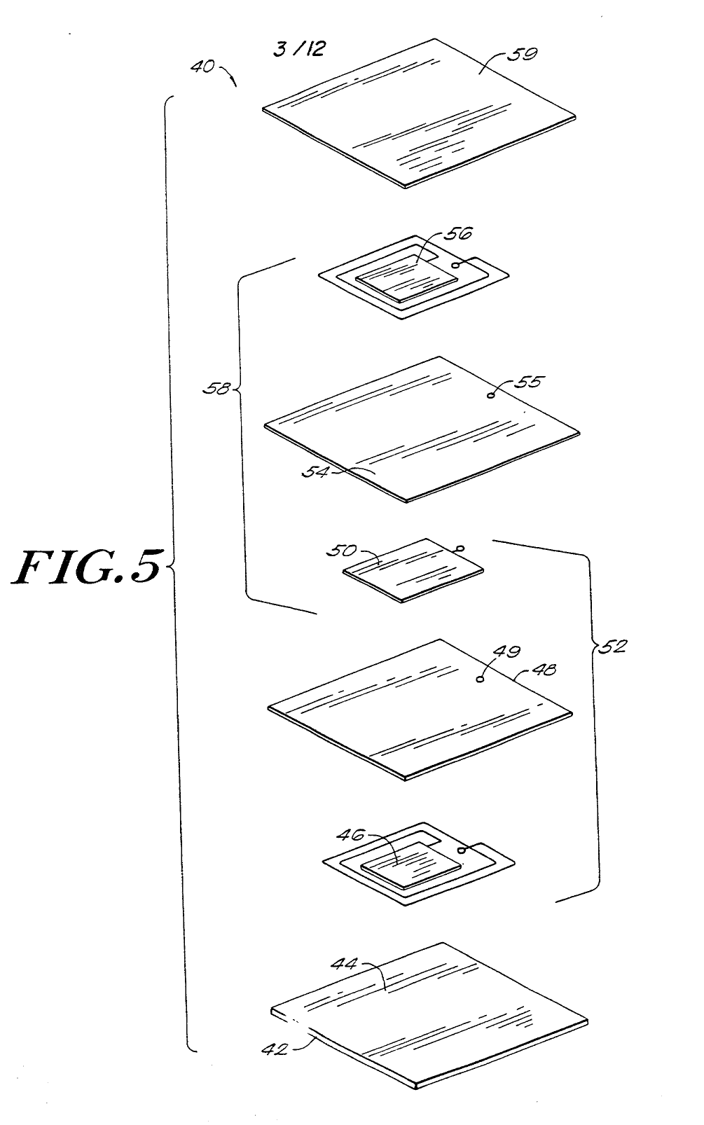

With reference to FIG. 6, a further embodiment of the resonant tag label 60 is shown. The label 60 is constructed in a planar manner, for example in a row as illustrated, to include adjacently disposed tuned antenna circuits 62a, 62b, through 62n. Each of these antenna circuits may be produced in accordance with the label construction disclosed for example in FIG. 1, 2 or 3. The planar construction of label 60 provides a less expensive process for producing a resonant tag label which is responsive to a plurality of frequencies as compared to the stacked construction of label 40 illustrated in FIG. 5. Alternatively, the adjacently configured construction or the stacked construction can operate to be stimulated by a single frequency and transmit a plurality of possibly differing frequencies.

Both the resonant tag labels 40 and 60 have operational applications in identification and surveillance systems. For example, a resonant tag label can be constructed with ten different frequency tuned antennas for exposure to a multiple frequency generation source, ideally having ten frequencies corresponding to each of the ten antennas. In operation, predetermined ones of the antennas are selectively deactivated either during construction (e.g., selective demetallization, etc.) or prior to application (e.g., destructive frequency field, mechanical interference, etc.).

For a resonant tag label with ten antenna circuits, there are 1023 discrete combinations of tuned antenna responses when ignoring the combination where all of the circuits are deactivated yielding no response. Accordingly, for N antenna circuits, there are 2^{N-}1 discrete operational responses. The operation of this type of label structure is suitable, for example, in sorting processes in which the object carrying the label is randomly oriented. Unlike bar codes (UPC), the resonant tag labels in accordance with the present invention operate to provide frequency responses independent of orientation.

With reference now to FIG. 7, another alternative embodiment of a thin transferrable resonant tag label 70 in accordance with the present invention is shown. The resonant tag label 70 includes a carrier film 71 with a patterned breakcoating 72 applied to one surface thereof. A first electrically conductive layer 73 is then applied over the entire surface of the film 71 and the breakcoat pattern 72. The conductive layer 73, for example, is formed from any conventional coating technique as described heretofore. A dielectric coating 74 is thereafter applied to the conductive layer 73, in a manner such that a gap or hole 75 is registered to a predetermined portion of the conductive layer 73. A second electrically conductive layer 76 is applied over the entire dielectric coating including the area registered with the hole 75. Accordingly, the hole accommodates contact between the first and second electrically conductive layers, thus forming the configuration of the resonant circuit. Finally, an adhesive layer 77 is applied to overlie the second conductive layer 76.

The adhesive layer alternatively may be applied in a registered manner so as to only overlie those portions of the label 70 constructed on top of the patterned breakcoating 72. In either construction, the circuitry of the resonant tag label 70 is formed by affixing the adhesive layer 77 to the desired receiving surface and thereafter removing the carrier film. Those areas overlying the patterned breakcoating will be the only areas which transfer to the receiving surface due to the fact that in the preferred embodiment, the adhesive has a peel strength greater than that required to separate the carrier film from the breakcoating but less than that required to separate the carrier film from the conductive layer 73. Thus those label portions not overlying the breakcoat are ripped away from the receiving surface as they are not released from the carrier film 71.

Accordingly, the resonant tag label 70 is of a frangible construction and includes at least two conductive layers that are disrupted and configured to define an electrical circuit during removal of the carrier film. The label is transferrable from the carrier film onto a receiving surface and is otherwise inseparable from the carrier film without attendant disruption and destruction of the resonant tag circuit.

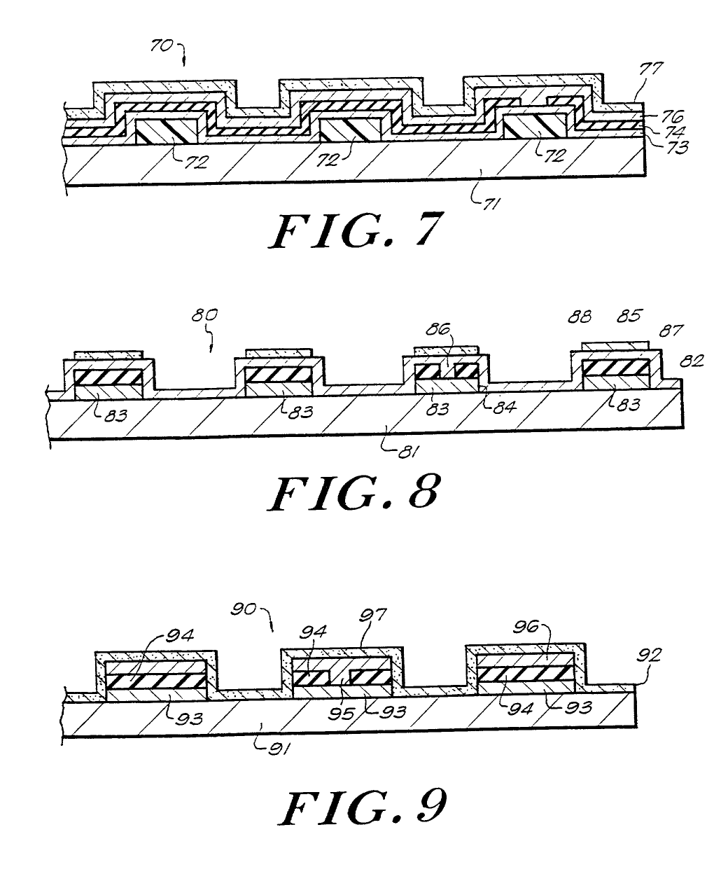

FIGS. 8 and 9 respectively show additional alternative embodiments of resonant tag labels 80 and 90 in accordance with the present invention. Resonant tag label 80 includes a carrier film 81 having at least one releasable surface 82 on which is applied a patterned electrically conductive layer 83. The conductive layer 83 may be continuously applied and thereafter selectively demetallized to leave gaps 84 so as to provide the resonant circuit configuration. It will be appreciated that the patterned conductive layer 83 may also be provided through patterned metallization coating of the releasable surface 82, or other conventional metallization patterning techniques such as etching of a metallic foil, etc. Thereafter, a dielectric coating 85 is applied in registered fashion so as to overlie only the patterned conductive layer 83. The dielectric coating 85 is also registered to include holes 86 to allow for the formation of the circuitry.

Thereafter, a second continuous electrically conductive layer 87 is applied to the structure and overlaps all surfaces including a connection to the first conductive layer 83 through the hole 86. Finally, a patterned adhesive layer 88 is applied in a registered manner to those areas which will be transferred to the desired receiving surface. Only those layers underlying the adhesive pattern will be transferred to the receiving surface, thus forming the circuitry of the resonant tag label as the carrier film is removed.

FIG. 9 shows a similar configuration of the resonant tag label 90 having a carrier film 91 with a release surface 92 on which is initially applied a first conductive pattern 93. A patterned dielectric coating 94 is applied to the conductive pattern 93 with registered holes 95. Thereafter, a second registered conductive pattern 96 is applied to overlie the dielectric coating. A connection between the first and second conductive patterns occurs via the registered hole 95. Finally, a continuous adhesive layer 97 is applied to overlie the entire surface of the label construction.

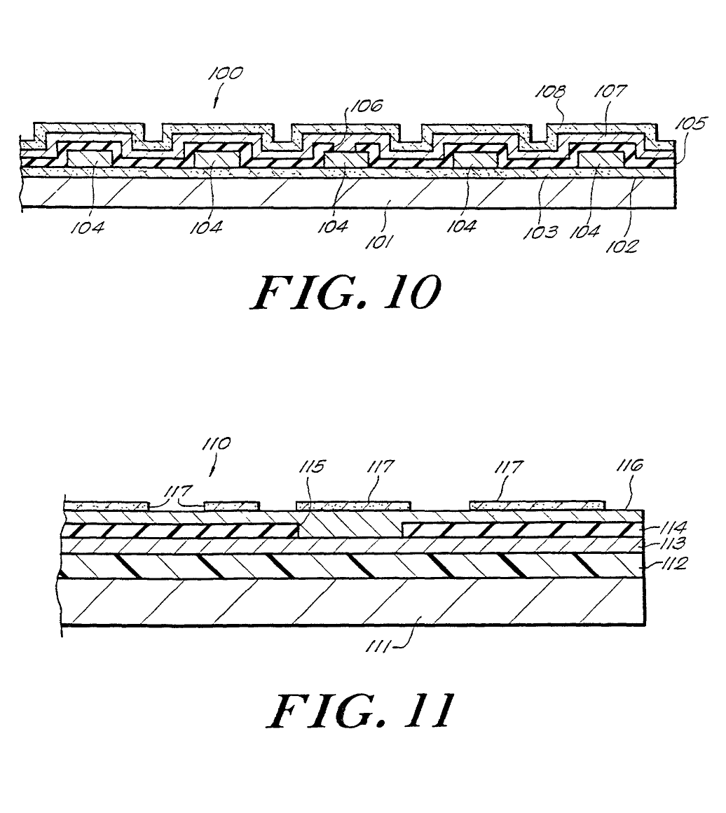

FIG. 10 shows a resonant tag label 100 as a further alternative embodiment of the present invention. The resonant tag label 100 includes a carrier film 101 having a release surface 102 on which is applied a continuous adhesive layer 103. The adhesive layer is preferably of the pressure-sensitive type. A first electrically conductive pattern 104 is applied to the adhesive with either a conventional registration technique or demetallization of a continuous coating. A dielectric layer 105 is applied to overlie the adhesive layer and the conductive pattern 102, and includes registered holes 106 for accommodating electrical connection to subsequent conductive layers. Thereafter, a continuous second electrically conductive layer 107 is applied to the structure, a portion of which contacts the conductive pattern 104 through the registered hole 106 in the dielectric layer. An optional second adhesive layer 108 can be applied to overlie the entire label structure.

The resonant tag label 100 is especially useful for applications in which the receiving surface includes its own adhesive coating, for example, the back of a previously coated pressure-sensitive label. In this configuration, the adhesive on the back of the substrate label acts as the bonding force to remove the circuit structure of the resonant tag label 100 from the carrier film 101. The resulting transfer of the resonant tag label will allow for the adhesive layer 103 to face in the same direction as the adhesive on the substrate label. Accordingly, this structure accommodates a more complete adhesive coverage to the back of the label, and for subsequent application of both the substrate label and the resonant tag label to a secondary receiving surface.

The utilization of the optional second adhesive layer 108 in the construction of the resonant tag label 100 is useful for application to a receiving surface which does not include an adhesive coating, yet subsequent to the transfer of the label 100, the adhesive layer 103 will be exposed for future bonding to any desired secondary receiving surface. In addition, depending on the severity of the environment of application, further dielectric coatings may be necessary to overlie the second conductive layer 107 or between the adhesive layer 102 and the remaining circuitry construction so as to add additional structural integrity, and/or protection against the harsh environment (thermal, shock, humidity, chemical, etc.).

FIG. 11 shows a further alternative embodiment of a resonant tag label 110 in accordance with the present invention. The resonant tag label 110 includes a carrier film 111 with a continuous breakcoating 112 applied to one surface thereof. A continuous first electrically conductive layer 113 is applied to the breakcoating 112 either by selective metallization or application of a conductive ink. A dielectric layer 114 is applied to the conductive layer 113 with a registered hole 115. A continuous second electrically conductive layer 116 is then applied to the dielectric layer, and contacts the first conductive layer 113 through the registered hole 115. Thereafter, a selected adhesive pattern 117 is applied to the second conductive layer. During application of the resonant tag label 110, the breakcoating 112 will release from the carrier film 111 in a pattern determined by the adhesive. Accordingly, only those layers underlying the adhesive are transferred to the desired receiving surface.

While heretofore the present invention has been described as a multi-layered structure forming a resonant tag circuit, it will be appreciated by those of skill in the art that the same construction technique can be used to form single layered resonant tags or either single or multi-layered circuits other than inductive capacitance resonating circuits. For example, the construction can include a single conductive layer which forms either resistance or capacitive properties used for applications in addition to that of a resonant tag system. The fabrication techniques described herein provide thin transferable circuit systems which can be used in almost any circuit configuration.

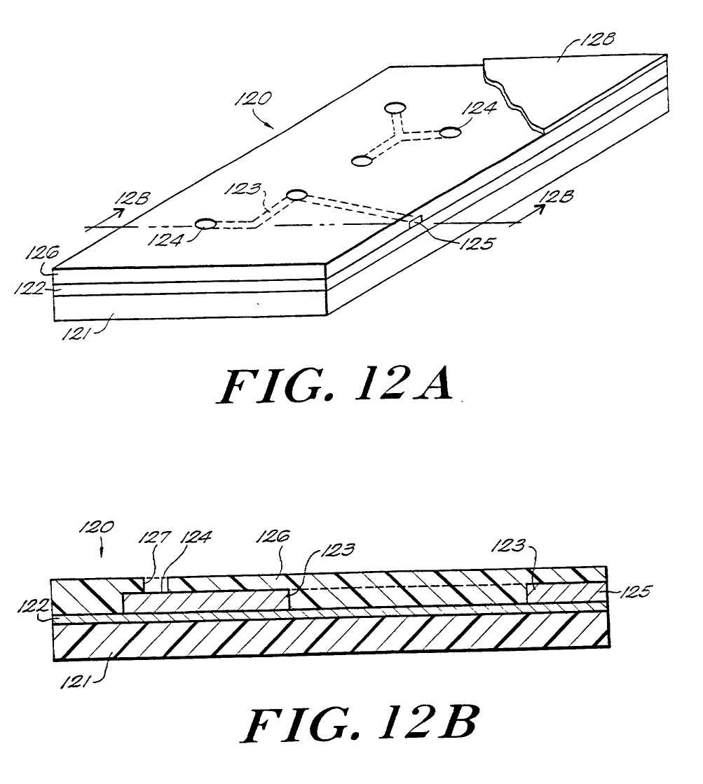

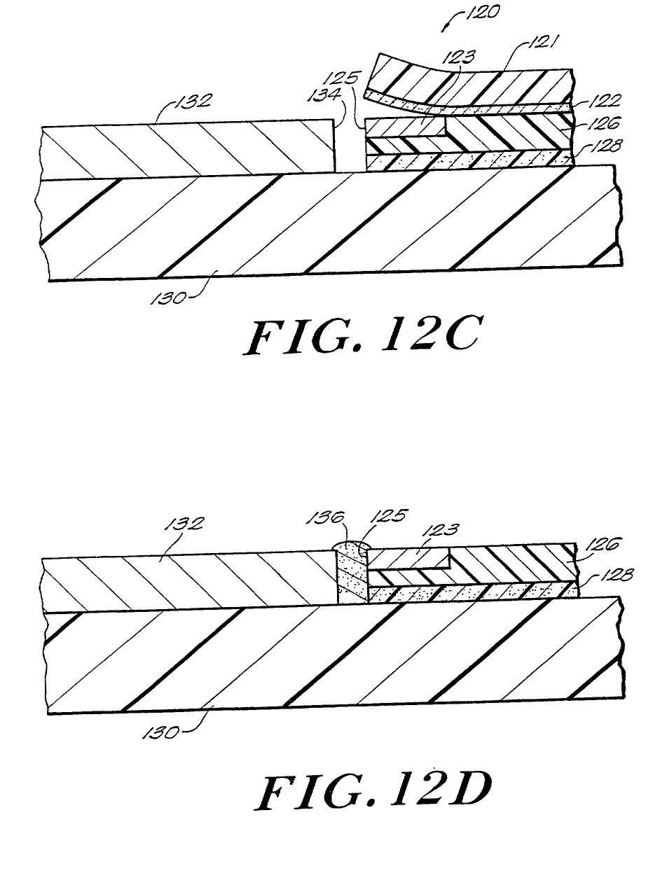

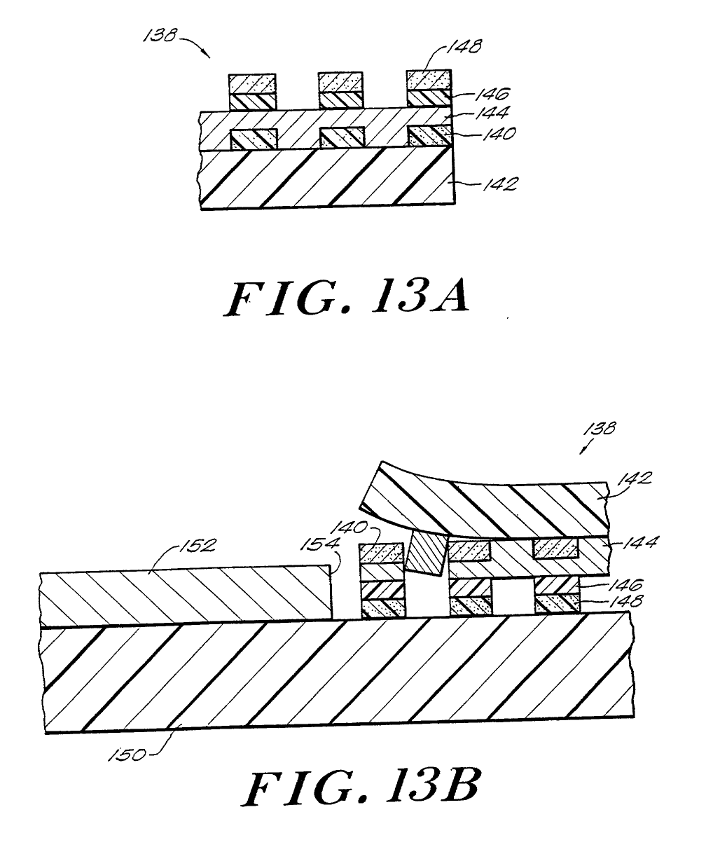

FIGS. 12A-12D show an exemplary embodiment of a thin film transferrable composite 120. As shown in FIG. 12A, the composite 120 includes a carrier film 121, with a release coating 122. As shown in FIG. 12B, a conductive pattern 123 forming a desired circuit is applied to the release coating 122. A dielectric layer 126 is applied in a registered manner so as to provide holes 127 that serve to expose portions of the conductive pattern which are used as circuit contact points. The exposed side opening 125 may also be used as a circuit contact point as shown in FIGS. 12B-12D. An adhesive 128 may then be applied to the exposed surface of the dielectric 126 as shown in FIGS. 12A and 12C in a registered pattern to avoid holes 127, if any. Alternatively, an adhesive layer could replace the dielectric layer 126 in the construction.

As shown in FIG. 12C, the thin film transferrable composite 120 includes an electrical component 123, and may be applied via adhesive 128 to a receiving substrate 130 that includes a receiving electrical circuit 132. The placement of the composite 120 is positioned to leave a small space as indicated at 134. The carrier film 121 and release coating 122 may then be separated from the applied conductor-dielectric-adhesive structure as illustrated. The conductive pattern 123 may then be directly connected to the receiving electrical circuit 132 by depositing an electrically conductive ink into the space 134 so as to electrically bridge the conductive pattern 123 with the circuit 132. In other embodiments, the pattern 123 may be inductively coupled to the electrical circuit 132.

Accordingly, the circuit composite 120 is of a frangible construction and includes one conductive layer that is configured to define an electrical component. The label is transferrable from the carrier film onto a receiving surface and is otherwise inseparable from the carrier film without attendant disruption of the electrical component.

An advantage of such a circuit system is that a single conductive layer or pattern may be registered to a specific location in an overall circuit design. More complex systems may be designed with multiple layers, each incorporating selective capacitance, resistance, or other such circuit elements through stacking of layer levels as described herein.

Moreover, the ultimately desired circuit is not completed until the thin film transferable electrical component is transferred to the receiving structure. This electrical component that is transferred may be, for example, an inductor coil. The invention may be employed to fabricate a wide variety of electrically responsive (and/or electromagnetically responsive) devices and components. For example, a break coat may be preprinted in the pattern of the desired electrical component on a continuous web or carrier.

As shown in FIG. 13A, another embodiment a thin film transferable composite 138 of the invention provides a patterned breakcoat 140 that is deposited onto a carrier film 142. To the pattern coated side of the carrier film 142 is applied a continuous non-patterned conductive layer 144 of a vacuum deposited aluminum to a deposition thickness of between about 1,000 Å-300,000 Å with a preferred range of about 10,000 Å to 30,000 Å. Registered to the breakcoat 140, a dielectric layer 146 is applied on top of the conductive layer 144. The addition of a patterned adhesive 148, registered to the break coat 140 as well as to the dielectric 146 completes the desired transferable system. In other embodiments, the dielectric material itself may have sufficient adhesive properties that the dielectric alone may serve as the dielectric as well as the adhesive. In any event, the dielectric coating 146 must adhere to the conductive layer 144 (with or without additional adhesive) with a greater boding strength than the strength by which the breakcoat 140 adheres to the carrier film 142. A releasable surface may also be provided on the side of the carrier 142 opposite the breakcoat 140 to permit the thin film transferrable composite to be rolled upon itself, i.e., so that the underside (as shown in FIG. 13A) of the carrier film 142 does not adhere to the adhesive 148.

As shown in FIG. 13B, the thin film transferable composite 138 may be applied via adhesive 148 to a receiving substrate 150 that includes a receiving electrical conductor 152. As the carrier film 142 is removed, all of the portions of the composite 138 that align with the breakcoat pattern 140 remain with the receiving substrate, including the breakcoat pattern 140 itself. The continuous metal conductor 144 breaks apart to form the patterned electrical component of the thin film transferable composite upon application to the substrate. The patterned electrical composite may then be directly or inductively connected to the receiving electrical circuit as discussed above. For example, a drop of conductive ink may be deposited in the opening 154 defined by the receiving electrical circuit and the transferred composite as shown in FIG. 13B.

In other embodiments, the adhesive may be applied to the receiving substrate either in addition to or instead of providing an adhesive on the transferrable composite. The electrical component of such a thin film transferrable composite could be used to complete a capacitor of an EAS tag, for example, if the adhesive 148 (or dielectric with adhesive properties) were used to bond directly to a receiving conductive layer.

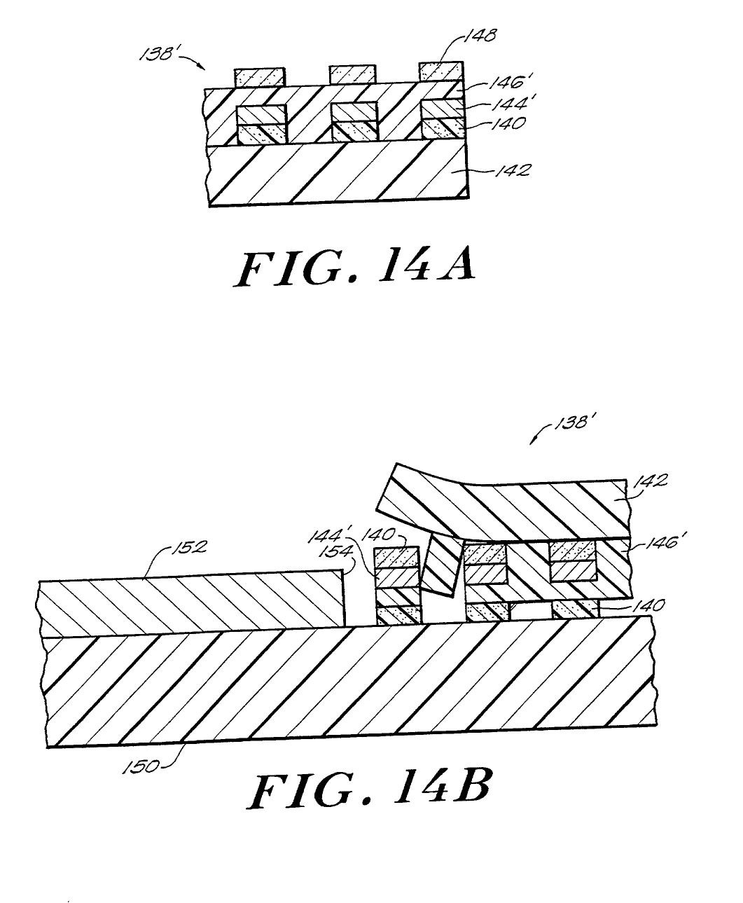

FIGS. 14A and 14B show another embodiment of a thin film transferrable composite of the invention similar to that shown in FIG. 13 (and using similar reference numerals to refer to the same components), except that the electrical conductor 144′ is deposited in a pattern matching that of the breakcoat 140, and the dielectric layer 146′ is deposited as a continuous layer. As shown in FIG. 14B, the dielectric layer 146′ breaks apart upon application to a receiving substrate 150 and subsequent removal of the carrier film 142.

In further embodiments, other thin film transferrable composites with different pattern designs of breakcoatings could be used to transfer inductors or fusible links etc. to receiving structures. In the embodiment shown in FIGS. 13A and 13B, the patterned conductive layer 144 is covered by the breakcoat 140. In other embodiments, it may be desired to leave the electrical component of the thin film transferrable composite exposed following transfer.

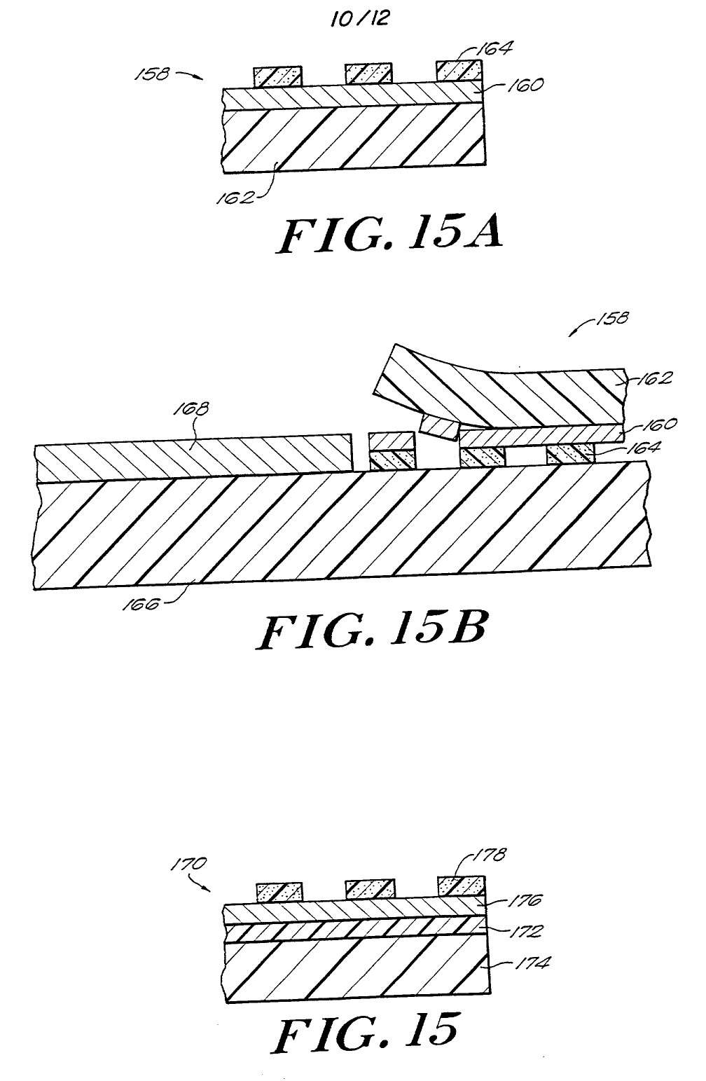

As shown in FIG. 15A, another embodiment of a thin film transferrable composite of the invention 158 includes a continuous electrically conductive layer 160 applied to a carrier film 162. The carrier film 162 may be, for example polypropylene, which has low intrinsic surface energy and is therefore inherently releasable. In other embodiments, a release coating, of for example silicone, may be applied to the carrier film 162 prior to depositing the conductor material 160 so that the release coating is intermediate the carrier film 162 and conductor material 160. A patterned adhesive 164 is then applied to the exposed surface of the conductor material 160. The adhesive should be in the pattern of the desired electrical component to be transferred.

As shown in FIG. 15B, when the composite 158 is applied to a receiving substrate 166, and the carrier film 162 is removed, the electrically conductive composite is broken apart to form the desired pattern. The adhesive strength of the conductive material 160 to the carrier film 162 must be less than the adhesive strength of the conductive material 160 to the carrier film 162. The patterned electrically conductive component 160 of the composite 158 may then be directly connected to a receiving electrical circuit 168 as discussed above using a conductive ink. In other embodiments, a patterned dielectric material may be deposited onto the electrically conductive material 160 prior to application of the patterned adhesive 164 in the same pattern as the adhesive 164. In further embodiments, adhesive may be deposited onto the receiving substrate 166 prior to transfer of the composite 158 onto the substrate 166.

FIG. 15C shows another embodiment of a thin film composite 170 of the invention in which a release coating 172 of silicone is deposited onto a 1.5 mil polyester film 174. An electrically conductive component 176 of aluminum is then vacuum deposited onto the release coating 172 as a continuous layer. A patterned adhesive layer 178 may then be applied to the conductive layer in the shape of a desired circuit, e.g., a membrane switch. This composite may then be transferred to a receiving substrate as discussed above.

In further embodiments, a thin (60 Å-4,000 Å, and preferably 100 Å-1,000 Å) sputter deposited coating of a material such as an Indium/Tin oxide or In/SnO) may be applied, followed by a heavy conductive layer of Aluminum. This would yield a material with a higher conductivity at a lower total cost with an enhanced surface abrasion resistance. This also provides less potential for corrosion since intermediate layers may be deposited between mutually corrosive materials. Similarly, other metal combinations may be employed to optimize conductivity, corrosion resistance and cost.

In still other embodiments, the metal transfer may be substituted for conductive ink (e.g. aluminum, silver, or carbon filled inks). Such a composite may be suitable for in situ applications as battery testers. In this case, it is necessary to have a controlled level of circuit resistance that will change temperature when the circuit is connected to the battery. A thermochromatic ink then changes color to indicate the useful capacity remaining in the battery. When using conductive inks, attention must be paid to material costs, the uniformity of the ink mixture, the size of the metallic particles, the uniformity of the printing, and manufacturing expenses involved, for example, in drying and/or curing.

The electrically conductive component of thin transferrable composites of the invention may be formed to a narrow range of resistance and applied relatively easily. Since the length and width may be easily altered, the circuit to which the conductive component is attached may be easily tuned to a desired level. The transfer of a conductive component in accordance with the invention could facilitate the fabrication of smart cards or smart labels to be applied to a wide variety of items, and the receiving conductor may include an integrated circuit chip.

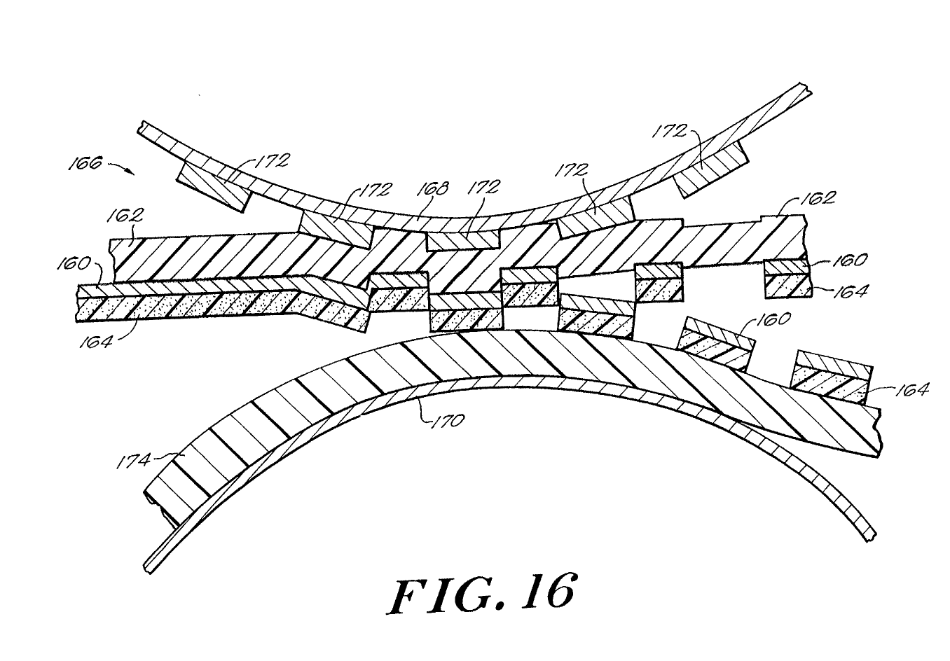

As shown in FIG. 16, in another embodiment of the invention, an aluminum conductor 160 is vacuum deposited to about 300 to 300,000 Å continuously onto a carrier film 162 having a low intrinsic surface energy. A heat activated adhesive coating 164 is then also continuously applied over the conductor 160. This thin film composite 166 is then fed between two rollers 168 and 170. The roller 168 includes heated dies 172 in the pattern of the patterned electrical component that is desired. Each die 172 may either be in the pattern of the complete component, or may represent a portion of the desired component pattern. In the transfer process, when the raised area of the dies 172 contact the composite, the adhesive achieves a melt and the pressure provided by the nip between the rollers serves to bond the composite to a receiving substrate 174. The adhesive strength of the substrate 174 to the adhesive 164 exceeds the shear strength of the conductive layer 160, thereby effecting transfer. The presence of the adhesive 164 on the conductive material 160 adds structural strength to the extremely thin conductive layer 160, filling any imperfections in the layer 160, and thereby facilitating handling of the composite 166. In another embodiment, transfer may occur by having the adhesive positioned on the receiving substrate. In this event, it may be possible to achieve a bond without the dies 172.

As shown in FIG. 17, another application of a thin film transferable composite of the invention, is to apply a patterned adhesive and conductor composite 180 to a receiving circuit 182. As shown in exploded view for clarity, the receiving circuit 182 includes a first electrical conductor 184 and a dielectric material 186 on the conductor 184. The composite 180 is transferred to the receiving substrate in accordance with the transfer methods of any of the above disclosed embodiments.

The dielectric material 186 covers the capacitor plate portion of the conductor 184, and extends toward the opposite end of the inductor coil 188. The composite 180 includes a patterned adhesive 190 and a matching patterned electrical conductor 192. As shown in FIG. 17, the composite 180 extends to the end portion 188 of the inductor coil. This over-lap area indicated at A provides an inductive coupling between the composite 180 and the receiving substrate. The amount of over-lap at A is a function of the desired resistance of the EAS tag circuit, the desired capacitance, the desired thickness and the desired dielectric constant. Note that the adhesive 190 is flexible enough that it will contact the dielectric material 186 as well as the underlying inductor coil 184 in the area of the end portion 188 of the coil. In other embodiments, a the capacitor 186 may be omitted, and the capacitance of the EAS tag circuit may rely solely on the dielectric properties of the adhesive 190. In either case, an inductive coupling may be established between the two conductors 184 and 192.

An advantage of the embodiments of the present invention that involve a printed adhesive, is that by printing the adhesive in the pattern of the desired patterned electrical component, and then transferring the patterned electrical component, circuits may be fabricated less expensively than by conventional copper etching, which typically results in relatively thick substrates, or by conventionally forming large conductive areas using conductive inks, which are relatively expensive.

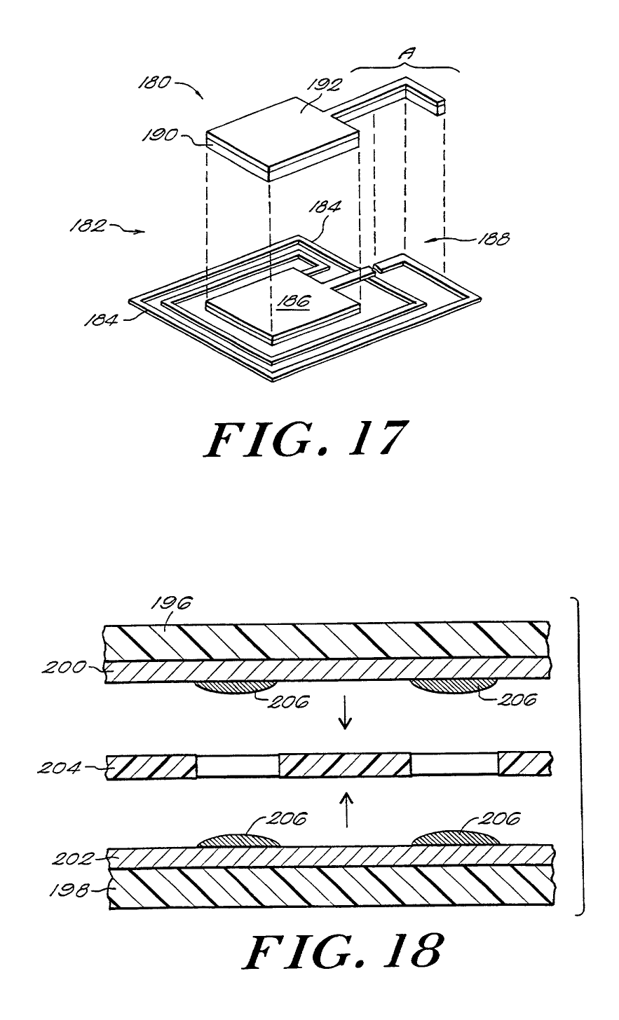

For example, the invention is also suitable for the manufacture of micro-motion (or membrane) switches, e.g. touch screens. As shown in FIG. 18, these switches typically include two substrates 196 and 198, each having a conductive patterned surface 200 and 202 on mutually opposing sides of the substrates 196 and 198, as well as a spacer film 204 between the conductive surfaces on the substrates as shown. Raised conductive ink portions 206 may be deposited on the patterned electrical conductors 200 and 202 in alignment with openings 206 in the spacer film 204 to improve abrasion resistance. The raised portions are formed of conductive ink and are designed to contact each other when the substrates 196 and 198 are brought together through actuation of the switch. In certain embodiments, the spacer film 204 may be coated on both sides with a pressure sensitive adhesive to facilitate bonding of the three layers together. When bonded, the ink portions 206 do not quite make contact, requiring a slight depression to form a bridge between the two conductive portions 200 and 202.

Conventional membrane switches typically include either copper etched circuit patterns to form the conductor portions 200 and 202, or use a significant amount of conductive ink to form these conductor portions. In accordance with the invention, the substrate 196 and conductive patterns 200 and 202 may be formed from a thin film transferrable composite.

In additional embodiments of the invention, dielectric layers could be added along with additional conductive layers, allowing for selected inter-planar contacts, to yield a stacked or three-dimensional circuit design.

Applications of thin film transferrable composites in accordance with the invention also include depositing metallic antennas on items to function as radio frequency tags that may, for example, be placed on automobile windows to provide rapid identification (e.g., for use at toll booths).

The foregoing description has been set forth to illustrate the invention and is not intended to be limited. Since modifications of the described embodiments incorporating the spirit and substance of the invention may occur to persons skilled in the art, the scope of the invention should be limited solely with reference to the appended claims and the equivalents thereof.

What is claimed is:

1. A thin film transferrable composite comprising:
a carrier film;
a first electrically conductive material formed as a deposit on said carrier film and being integrally associated with first portions of said composite, and separably associated with second portions of said composite; and
adhesive means arranged to coact with said first electrically conductive material for applying said composite to a receiving surface, said carrier film being separable from said second portions of said electrically conductive material with said first portions of said electrically conductive material remaining with said carrier film, said second portions of said electrically conductive material defining a transferrable electrical component.

2. A composite as claimed in claim 1, wherein said composite further includes a dielectric material.

3. A composite as claimed in claim 1, wherein said adhesive means further includes an adhesive coating applied to the exposed surface of said electrically conductive material.

4. A composite as claimed in claim 1, wherein said adhesive means further includes a patterned adhesive applied to the exposed surface of said electrically conductive material, and said pattern is the form of a desired electrical circuit.

5. A composite as claimed in claim 1, wherein said electrically conductive material is deposited as a continuous layer, and said second portions of said electrically conductive material form a desired electrical component.

6. A composite as claimed in claim 1, wherein said transferred electrical component includes an inductor.

7. A composite as claimed in claim 1, wherein said transferred electrical component includes a capacitor plate.

8. A composite as claimed in claim 1, wherein said transferred electrical component is adapted to be electrically coupled to a receiving electrical circuit on said receiving surface.

9. A composite as claimed in claim 1, where said transferred electrical component is adapted to be inductively coupled to a receiving electrical circuit on said receiving surface.

10. A composite as claimed in claim 1, wherein said electrically conductive component of said composite has a thickness of between about 10 Å and 50,000 Å.

11. A composite as claimed in claim 1, wherein said electrically conductive component is otherwise inseparable from said carrier film without attendant disruption of said conductive component.

12. A thin film transferrable composite comprising a frangible electrically conductive material, a carrier substrate, and adhesive means for adhering said composite to a receiving substrate such that upon application of said composite to the receiving substrate, said carrier film may be separated from at least portions of said electrically conductive material, thereby transferring said separated portions of said electrically conductive material to the receiving substrate.

13. A composite as claimed in claim 12, wherein said composite further includes a dielectric material.

14. A composite as claimed in claim 12, wherein said adhesive means further includes an adhesive coating applied to the exposed surface of said electrically conductive material.

15. A composite as claimed in claim 12, wherein said adhesive means further includes a patterned adhesive applied to the exposed surface of said electrically conductive material, and said pattern is the form of a desired electrical circuit.

16. A composite as claimed in claim 12, wherein said electrically conductive material is deposited as a continuous layer, and said remaining portions of said electrically conductive-material form a desired electrical component.

17. A composite as claimed in claim 12, wherein said transferred electrical component includes an inductor.

18. A composite as claimed in claim 12, wherein said transferred electrical component includes a capacitor plate.

19. A composite as claimed in claim 12, wherein said transferred electrical component is adapted to be electrically coupled to a receiving electrical circuit on said receiving substrate.

20. A composite as claimed in claim 12, where said transferred electrical component is adapted to be inductively coupled to a receiving electrical circuit on said receiving substrate.

21. A composite as claimed in claim 12, wherein said electrically conductive component of said composite has a thickness of between about 10 Å and 50,000 Å.

22. A composite as claimed in claim 12, wherein said electrically conductive component is otherwise inseparable from said carrier film without attendant disruption of said conductive component.

23. A method of forming an electrically conductive material in a desired pattern on a substrate, said method comprising the steps of:
depositing an electrically conductive material onto a carrier film;
applying said carrier film to said substrate with an adhesive such that at least portions of said electrically conductive material adhere to said substrate; and
removing said carrier film from said substrate such that said portions of said electrically conductive material remain with said substrate in the form of said desired pattern of conductive material.
